(19) United States
(12) Patent Application Publication
(10) Pub. No.: US 2012/0151121 A1
(43) Pub. Date: Jun. 14, 2012

(54) Solid State Non-Volatile Storage Drives Having Self-Erase and Self-Destruct Functionality and Related Methods

(76) Inventor: Jose Antonio Braga, Raleigh, NC (US)

(21) Appl. No.: 12/967,355

(22) Filed: Dec. 14, 2010

(51) Int. Cl. G06F 12/00

(52) U.S. Cl. 711/103; 711/E12.008

(57) ABSTRACT

Solid state storage drives for a host computer are provided that include a solid state memory cell array that includes a plurality of non-volatile memory cells, a first processor that is configured to control write and read operations to and from the solid state memory cell array, and to perform block erase operations on blocks of the solid state memory cell array, and a second processor that is configured to block erase all blocks of the solid state memory cell array in response to a user input self-erase command. These solid state storage drives may further include self-destruct functionality which can be used to render the drive unusable and to inhibit efforts to forensically recover data that was previously stored on the drive.

### FIELD OF INVENTION

The present invention relates to computer memories and, more particularly, to solid state non-volatile memory storage drives.

### BACKGROUND

The personal computer is an integral tool of many, if not most, work functions in the modern world. Essentially every personal computer includes at least one memory storage drive where system software, application programs, data and/or other information is stored. Memory storage drives (“storage drives”) are non-volatile memory devices in that they retain the data stored therein even when the storage drive is disconnected from a power source. The most prevalent storage drive is the hard disk drive in which data is stored on a rotating magnetic disk. More recently, solid state storage drives have been introduced which comprise one or more arrays of non-volatile semiconductor memory cells. Data stored on a host computer can be transferred to the memory storage drive and vice versa.

Most storage drive may be disconnected physically and electrically from the host computer. Moreover, these storage drives may be removed in the field, both to replace defective or crashed units or to swap-out properly functioning units for faster or higher capacity storage drives. When these storage drives are removed from their computers, they will typically still contain data that may be directly accessible by plugging the storage drive back into another computer and/or indirectly accessible using forensic data reconstruction techniques that are practiced for both legitimate and illegitimate reasons.

Sensitive files such as encryption keys, confidential designs, strategic plans and classified government information are commonly stored on the storage drives of personal computers. However, even when the files containing this information are deleted from the drive, the data may be recovered from the storage drive using data recovery techniques.

### SUMMARY

Pursuant to embodiments of the present invention, internal solid state storage drives are provided that include a solid state memory cell array that includes a plurality of non-volatile memory cells, a first processor that is configured to control read and write operations from/to the solid state memory cell array, and a second processor that is separate from the first processor, the second processor being configured to autonomously block erase substantially all of the data storage blocks of the solid state memory cell array in response to a user input self-erase command.

In some embodiments, the solid state storage drive further includes a housing that is configured to be received within a slot on a host computer, a battery that is mounted within the housing, and a power supply that is powered by the battery and configured to provide an autonomous and independent operating voltage to the second processor. The storage drive may also include a self-destruct circuit that is configured to deliver a high voltage to the solid state memory cell array. This self-destruct circuit may include a high voltage power supply that is powered by the battery via the power supply. In some embodiments, this high voltage power supply may be driven directly by one of the second processor's analog output lines, which is made to oscillate at a frequency of, for example, approximately 20 kHz to drive a 500:1 step-up transformer to supply destructive high voltage alternating current to the power bus and to the memory modules of the solid state memory cell array.

In some embodiments, the storage drive also includes a wake-up circuit that is configured to cause the second processor to exit a low power usage state in response to an input signal. The storage drive may have its own user input circuit that is separate from the user input circuits (e.g., keyboard, microphone, pointing device, etc.) of the host computer. The separate user input circuit of the storage drive may be configured to receive the self-erase command and/or a self-destruct command from the user. The storage drive may be configured to initiate a self-destruct process that renders the solid state memory cell array and other components of the drive inoperable in response to such a self-destruct command. In some exemplary embodiments, the separate user input circuit may be a button or switch. In other exemplary embodiments, the user input circuit may be a keypad.

In some embodiments, the storage drive may further include a power tap that taps power from a connection between the solid state storage drive and the host computer and a charging circuit that uses power received from the power tap to charge the battery. The storage drive may also include a user feedback circuit such as, for example, a buzzer, vibrator or display that is configured to provide feedback to the user in response, for example, to information input via the user input circuit.

Pursuant to further embodiments of the present invention, internal solid state storage drives are provided that include a housing. A solid state memory cell array, a battery, and an internal independent power supply circuit that receives power from the battery may be disposed within the housing. These storage drives further include a self-destruct circuit that is powered by the internal independent power supply circuit. The self-destruct circuit may be configured to deliver a high voltage to the solid state memory cell array that renders the memory cells of the solid state memory cell array inoperable in response to a user input self-destruct command.

In some embodiments, the self-destruct circuit may comprise a high voltage power supply circuit that is configured to direct high voltage to the solid state memory cell array, and a self-erase/destruct processor that is configured to cause the high voltage supply circuit to deliver the high voltage to the solid state memory cell array in response to the self-destruct command. The storage drive may also include a separate solid state drive (“SSD”) processor that is configured to control standard read, write, and erase operations of the solid state memory cell array. The housing may be configured to be received within an internal slot on a host computer, and the power supply may provide an operating voltage to the self-erase/destruct processor.

In some embodiments, the storage drive may also include a self-erase circuit that is configured to block erase all blocks of the solid state memory cell array in response to a user input self-erase command. The storage drive may also or alternatively include a wake-up circuit that is configured to cause the self-erase/destruct processor to exit a low power usage state in response to an input from the user that directs the self-erase/destruct processor to take over control of the solid state memory cell array from the SSD processor through the end of the self-erasure process. The storage drive may further include a monitoring circuit that monitors a power level of the battery.

Pursuant to still further embodiments of the present invention, methods of preventing access to data stored within a solid state memory cell array of an internal solid state storage drive are provided in which a self-erase command is received via a user input circuit. Pursuant to these methods, substantially all of the data storage blocks of the solid state memory cell array are block erased in response to the self-erase command. Thereafter, a high voltage may be delivered to the solid state memory cell array that renders the memory cells of the solid state memory cell array inoperable. The solid state storage drive may be configured so that the block erasing operations and the delivery of the high voltage can be initiated without powering up the host computer.

### BRIEF DESCRIPTION OF DRAWINGS

FIG. 1 is a block diagram of an internal solid state memory storage drive according to embodiments of the present invention that includes both self-erase and self-destruct capabilities.

FIG. 2 is a simplified schematic plan view of a 2.5 inch internal solid state storage drive according to embodiments of the preset invention.

FIG. 3 is a flow chart diagram that illustrates operations that may be performed to implement the self-erase and self-destruct functions on a solid state storage drive according to embodiments of the present invention.

FIG. 4 is a schematic diagram illustrating a self adhesive external button/keypad that may be used as a user input circuit in solid state storage drives according to certain embodiments of the present invention.

### DETAILED DESCRIPTION

Embodiments of the present invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. It will also be understood that elements and/or features of each of the embodiments described and pictured herein may be added to other embodiments to provide many additional embodiments, each of which are considered to be part of this disclosure. Likewise, various elements and/or features of each of the embodiments that are described and pictured herein may be omitted to provide yet additional embodiments. In the description that follows, like numbers refer to like elements throughout.

Pursuant to embodiments of the present invention, internal solid state non-volatile storage drives are provided that include automatic self-erase and self-destruct functionality. These solid state storage drives may serve as the main memory storage of, for example, desktop, laptop, notebook, tablet and netbook personal computers. The solid state storage drives according to embodiments of the present invention may include a self-erase subsystem that is backed by independent internal battery power which can perform an organized and autonomous purging of all or substantially all of the data stored in the solid state non-volatile memory cell arrays of the storage drive with the push of a button or other simple activation step. In addition, for military, intelligence and other users that require heightened security that can protect against the most sophisticated data recovery techniques, the solid state storage drives according to certain embodiments of the present invention may further include a self-destruct subsystem which can deliver a high voltage to key electronic components in the storage drive that renders the drive completely inoperable in order to make it highly unlikely that any potentially remaining data fragments are accessible via forensic reconstruction given the physical destruction of key elements of the drive, specifically including the solid state non-volatile memory cell arrays.

Conventional methods for safeguarding the data on storage drives that are removed from personal computers generally have a high degree of unreliability. As a result, confidential consumer information (e.g., identity information, credit card numbers, financial information, patient data, etc.), business information (trade secrets, research and development information, business plans, etc.) and classified military and intelligence information can be subject to theft when left on the storage drives of old computers after those computers are replaced in the normal course of business. Thus, entities that work with highly sensitive data may be required to provide their workers and operatives with procedures which can reliably cause the purging of all data that is stored on such storage drives. With respect to intelligence and military organizations, the need to quickly purge all data on these storage drives may be of critical importance in the case of attacks by enemy forces or other situations where highly classified data may be compromised unless it is immediately destroyed. Such organizations thus typically have in place rigorous procedures which need to be followed by operatives to dispose of data and storage devices in situations such as those described above. Current procedures for military and intelligence operatives typically involve the use of explosives and/or other destructive actions which may jeopardize the lives of the operatives and may restrict the locations where the data destruction procedure can be applied. In the business environment, workers in charge of highly sensitive data may need to purge data from computers in cases of imminent personal abduction, natural disasters, and the like.

As noted above, pursuant to embodiments of the present invention, solid state storage drives are provided that include self-erase and self-destruct sub-systems. The self-erase subsystem may be fully powered by an independent, internal battery which may guarantee the organized and autonomous purging of all stored data in the non-volatile memory cell arrays of the drive with, for example, a push of a button. In addition, the storage drive may further include a self-destruct subsystem which again may be powered by the independent, internal battery. The self-destruct subsystem can be used to electrocute key electronic components in the drive, rendering the drive inoperable, so that any potentially remaining data fragments are no longer accessible via forensic reconstruction given the physical destruction of the integrated circuit chips of the storage drive by high voltage discharges to the internal power bus.

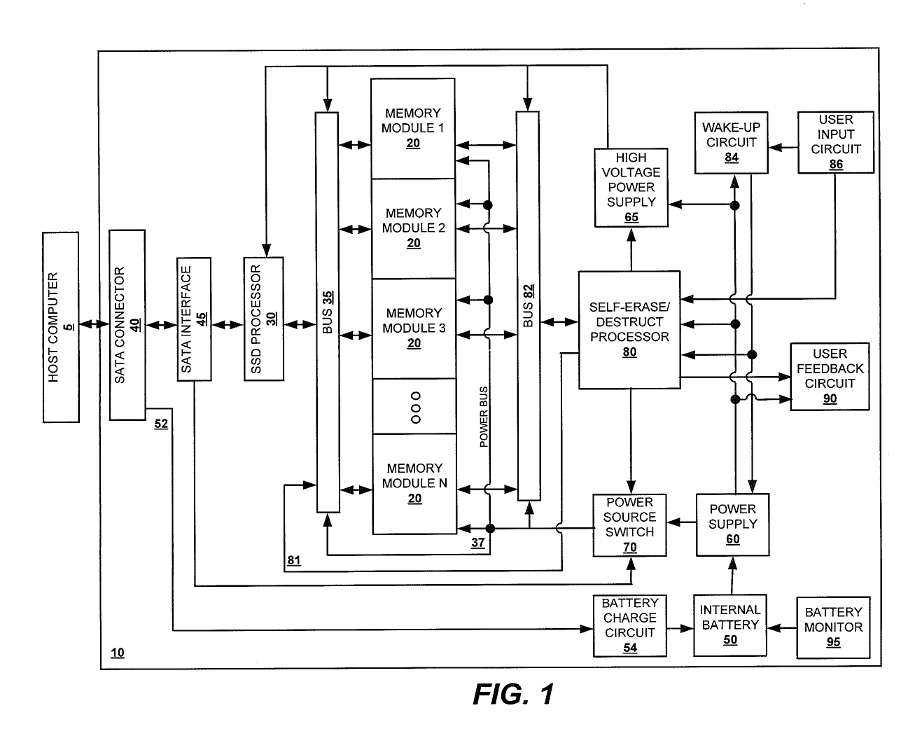

FIG. 1 is a block diagram of a solid state storage drive 10 according to certain embodiments of the present invention. The solid state storage drive 10 may include the functional components of a traditional solid state storage drive including, for example, a plurality of non-volatile memory cell array modules 20, a processor 30, and a connector 40 that provides the electrical connections between the storage drive 10 and a host computer 5. Generally, the host computer 5 writes data to, and retrieves data from, the solid state storage drive 10. The storage drive 10 may have a standard form factor for an internal drive bay of the host computer 5 (e.g., the form factor for either 3.5 inch or 2.5 inch drive slots). The storage drive 10 may also include other components and circuitry that are commonly included in conventional solid state storage drives. As such components and circuitry are well known to those of skill in the art, these conventional components will not be described herein.

In the illustrated embodiment, the non-volatile memory modules 20 comprise n separate NAND-type flash memory modules. However, it will be appreciated that other types of non-volatile memory modules 20 may be used including, for example, NOR-type flash memory modules, resistive memory cell array modules, magnetic random access memory modules, and/or other electrically-erasable programmable read only memory (EEPROM) devices. Any number of memory modules 20 may be included in the solid state storage drive 10.

The processor 30 may comprise any type of processor including, for example, a microprocessor, a microcontroller, a custom control logic circuit, a state machine, etc. In some embodiments, the processor 30 may comprise a digital microcontroller. The processor 30 may include built in memory storage (e.g., a read-only memory), a file system interface and/or file management capabilities. The processor 30 controls the reading and writing of data to the storage drive 10, as well as block erasing of blocks of the non-volatile memory modules 20. The processor 30 is powered by an operating voltage that is provided from the interface 45. The processor 30 is connected to the non-volatile memory modules 20 via an interface 35. In some embodiments, the interface 35 may comprise a data bus such as a 3-state bus transceiver that is controlled by the processor 30.

The connector 40 may provide the electrical connection between the storage drive 10 and the host computer 5. The connector 40 may comprise, for example, a standard Serial Asynchronous Transfer Adapter (“SATA”) connector which allows the storage drive 10 to be plugged into an internal cable or slot in the host computer 5 in which the storage drive 10 is mounted. Data is transferred to and from the storage drive 10 via the connector 40. The processor 30 may be connected to the connector 40 via an interface 45. The interface 45 may comprise, for example, a SATA interface 45. As known to those of skill in the art, a SATA interface may be used to perform signal conditioning on signals that are passed therethrough. As noted above, the SATA interface 45 also provides an operating voltage to the processor 30. In some embodiments, the interface 45 may be controlled by the processor 30. In other embodiments, the interface 45 may be controlled by a second processor 80, as will be explained in more detail below.

Electrical power may also delivered to the drive 10 from the host computer 5 via the connector 40. As will be discussed in more detail below, a power tap 52 is provided at the SATA connector 40 that is used to power various components of the storage drive 10 that provide the self-erase and self-destruction functionality. The SATA connector 40 may also provide the electrical power to the SATA interface 45. The SATA interface 45 may provide electrical power to a power source selector switch 70 (which is discussed in further detail herein). As shown in FIG. 1, the output of the power source selector switch 70 provides an operating voltage to a power bus 37. The power bus 37 provides operating voltages to the non-volatile memory modules 20, the data bus 35 and the data bus 82. While in the depicted embodiment the SATA interface 45 provides the power feed to the power source selector switch 70, it will be appreciated that, in other embodiments, the power tap 52 may instead provide the power to the power source selector switch 70, or other power connections may be provided.

As is also shown in FIG. 1, the storage drive 10 further includes circuitry that may be used to systematically erase and/or destroy each of the non-volatile memory modules 20 in order to prevent unauthorized and/or unwanted access to the data that is stored therein. This circuitry includes an internal battery 50, a battery charging circuit 54, an independent power supply 60, a high voltage power supply 65, a power source selector switch 70, a self-erase/destruct processor 80, and an interface 82. The storage drive 10 may also include wake-up circuit 84, a user input circuit 86, a user feedback circuit 90, and a battery monitor 95. The operation of each of these components will now be described.

The battery 50 may comprise, for example, a lithium-ion battery or other long-life, high storage capacity battery. The battery 50 may be powered via the power tap 52 that taps power from a power connection through the SATA connector 40. The battery charging circuit 54 receives power from the power tap 52 that is used to charge the battery 50. The battery 50 acts as an independent, internal power source for the circuitry that performs the self-erase and/or self-destruct sequences which occur in response to self-erase and/or self-destruct commands that are input by a user. Power taps and battery charging circuits are well known in the art, and it will be appreciated that the power tap 52 and the battery charging circuit 54 may be implemented in any conventional fashion in some embodiments.

The battery 50 provides power to the power supply 60 and to the high voltage power supply 65. The power supply 60 may be implemented as any conventional power supply. In some embodiments, the power supply 60 may comprise a voltage regulator that generates a power supply voltage that is provided, for example, to the active circuits that perform the self-erase and self-destruct functions. It will be appreciated, however, that the power supply 60 may be implemented in various other ways. The high voltage power supply 65 likewise receives power from the battery 50. Operation of the high voltage power supply 65 will be discussed in detail below.

The storage drive 10 further includes a second processor 80 that may be used to initiate and control operations of the above-described self-erase and self-destruct functions. The second processor 80 may comprise any type of processor including, for example, a microprocessor, a microcontroller, a custom control logic circuit, a state machine, etc. In some embodiments, the second processor 80 may be an application specific integrated circuit (ASIC). The second processor 80 may be powered by the independent power supply 60 and hence may retain full operating capabilities even when the storage drive 10 is removed from the host computer 5. The operations performed by the second processor 80 in managing the self-erase and self-destruct functions will be described in detail below. The second processor 80 is connected to the non-volatile memory modules 20 via an interface 82. In some embodiments, the interface 82 may comprise a data bus such as a 3-state bus transceiver that is controlled by the second processor 80. The data bus 82 may be formed of a material that can withstand a high voltage (e.g., a voltage of 500 or 600 volts) so as to be capable of delivering that voltage to the non-volatile memory modules 20. For example, in some embodiments the bus 82 may be formed using high dielectric substrates that can withstand the high voltages. Additionally, as noted above, in some embodiments, the second processor 80 may also control the interface 35 between the first processor 30 and the non-volatile memory modules 20.

The storage drive 10 further includes a power source selector switch 70. The power source selector switch 70 has a first input that receives power from the interface 45 that is provided from the host computer 5 through the SATA connector 40. The power source selector switch 70 has a second input that receives power from the independent power supply 60 that is powered by the battery 50. The power source selector switch 70 also includes a control input that receives a control signal from the second processor 80 that sets the state of power source selector switch 70 so that the power source selector switch outputs to the non-volatile memory modules 20 and the buses 35 and 82 either power supplied from the host computer 5 via the interface 45 (switch state 1) or power supplied by the independent power supply 60 (switch state 2).

The solid state storage drive 10 further includes a high voltage power supply 65. The high voltage power supply 65 may receive power from the independent power supply 60. In one exemplary embodiment, the high voltage power supply 65 is driven by a 20 kHz analog sine wave generated at one of the analog ports of the processor 80 which is used to drive the low voltage side of a 1:500 miniature step-up transformer resulting in some 600 volts of AC potential delivered on the high voltage side of the step-up transformer. As discussed below, this high voltage may be applied to the non-volatile memory modules 20, the processor 30 and other components of the storage drive 10. Other methods of generating a high voltage may also be used. In other embodiments (not shown in the figures), the high voltage power supply 65 may receive power directly from the internal battery 50. The high voltage power supply 65 is controlled by the second processor 80, and may be configured to generate and deliver a high voltage (e.g., a constant high voltage, a series of high voltage pulses, etc.) to certain of the electronics in the solid state storage drive 10, specifically including the non-volatile memory modules 20 and the processor 30.

The user input circuit 86 may comprise, for example, any electronic circuit and/or mechanical device that allows a user to input commands to the solid state storage drive 10. In one exemplary embodiment, the user input circuit 86 may comprise a two-wire connector and associated external mechanical push button or other activation mechanism that generates an electrical signal in response to being pushed or otherwise activated. A user may use the user input circuit 86 to initiate the self-erase and/or self destruct processes. In some embodiments, the user may input a special code (e.g., a series of pressings and releases of the external mechanical push button, a numeric or alphanumeric passcode on a keypad user input circuit, etc.) in order to assure that these processes are not started accidentally.

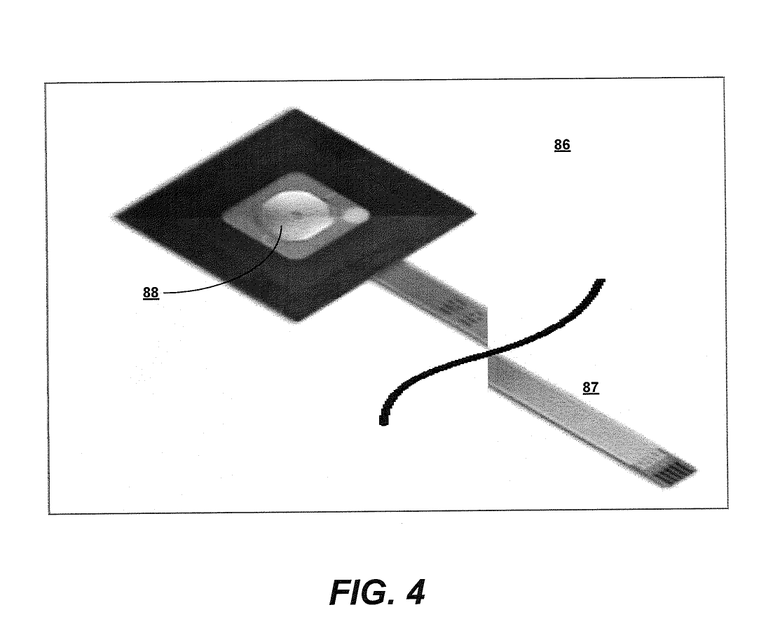

In one particular embodiment (see FIG. 4), the user input circuit 86 comprises a thin flat conductor wire pair 87 that connects, for example, the wake-up circuit 84 and/or the second processor 80 to a bubble push button 88 that may be adhesively affixed to, for example, the keyboard area of a laptop or desktop host computer. In some embodiments, the 2-wire connector 87 may be wired to one of the push buttons typically already available in the fascia of many computers (particularly desktop computers) such as the RESET or TURBO push buttons. By providing a user input circuit 86 that is external to the storage drive 10, a user may initiate the self-erase and/or self-destruct sequences without the need to either power up the host computer or disassemble it to remove the drive 10 to gain access to an internal destruct button or other activation mechanism on the drive 10 itself. This functionality may be particularly advantageous for individuals in the intelligence and military communities who may need to very quickly destroy their storage devices in certain situations.

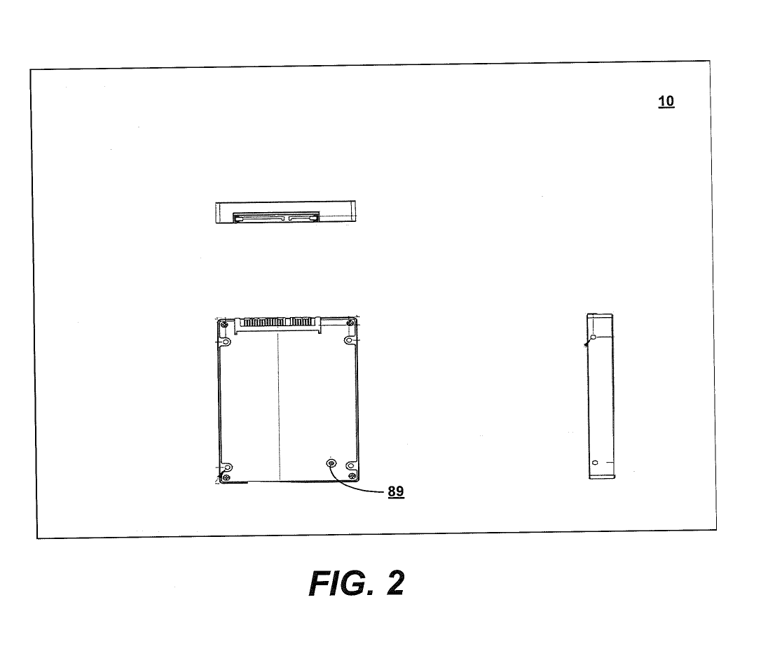

The storage drive 10 may alternatively or additionally be equipped with an internal button 89 (see FIG. 2) which may act as the user input circuit 86. The internal button 89 may function in exactly the same fashion as the external button 88. This internal button is typically used by the individual or IT department of an organization after the storage drive 10 is removed from the host computer to erase data from the storage drive 10 and/or to initiate the self-destruct process. When the user input circuit 86 includes an internal button 89, an IT manager or other individual may be charged with deciding whether or not to make the external button available on the outside of the host computer and directly accessible to the user so that the storage drive 10 may be erased and/or destroyed without any disassembly of the computer on which the storage drive 10 is installed. If the external button 88 is to be mounted on the exterior of the computer, the 2-wire connector 87 may be threaded through the computer case and connected to, for example, the internal button 89. In cases where the self-erase and self-destruct functionality is to be available only through the internal button 89, the solid state storage drive 10 may be installed following the exact installation procedure of a conventional SATA drive.

Because the solid state storage drive 10 may be disconnected from an external power source for quite some time, the electronics of the drive 10, including the independent self-erase and self-destruct circuit, may be set in a low-power consumption sleep mode in which they only draw a small amount of current from the battery 50 until the circuit is “woken up” by, for example, an initial push of the external push-button 88 or other activation that is input via the user input circuit. The wake-up circuit 84 may comprise, for example, a logic circuit that receives signals from the user input circuit 86. As described in more detail below, the wake-up circuit 84 may generate a “wake-up” signal in response to a signal from the user input circuit 86 and deliver this wake-up signal to other components of the solid state storage drive 10 such as, for example, the high voltage power supply 65 and the independent power supply 60 and/or the second processor 80. When the user activates the user input circuit 86, a signal is generated that is provided to the wake-up circuit 84. In response thereto, the wake-up circuit 84 may send a signal that brings the components of the storage drive 10 that are in sleep mode out of sleep mode so that the second processor 80 may determine if a user is entering a self-erase and/or self-destruct command. In the depicted embodiment, the wake-up circuit 84 sends a single signal to the second processor 80, and the second processor 80 then may determine whether or not the other components of storage drive 10 should be “woken-up” from sleep mode. In some embodiments, the wake-up circuit 84 may evaluate the signals received from the user input circuit 86 and only wake-up the second processor 80 and/or other components of the solid state storage drive 10 when the wake-up circuit 84 determines that either a self-erase and/or a self-destruct command has been received from a user. If the second processor 80 determines that the signal received from the user input circuit 86 does not indicate an intention by the user to initiate the self-erase or self-destruct sequences (i.e., because a full activation passcode was not entered), then the internal circuitry of the drive 10 may return to the low-power sleep mode. On the other hand, if the second processor 80 determines that an input that was entered into the user input circuit 86 indicates an intent to erase all data on the drive 10 and/or an intent to electronically destroy the drive 10, then the drive electronics do not return to sleep mode and instead initiate the appropriate self-erase and/or self-destruct operations. As shown in FIG. 1, in some embodiments, the user input circuit 86 may provide signals to both the wake-up circuit 84 and to the second processor 80. In an alternative embodiment, the wake-up circuit 84 can be omitted and the functionality thereof can be incorporated into the second processor 80. In other embodiments, the functionality of the wake-up circuit 84 may be omitted entirely.

In some embodiments, the storage drive 10 further includes a monitoring circuit 95 that monitors the power level of the battery 50. The monitoring circuit 95 may provide power level information to the second processor 80. In some embodiments, the second processor 80 may notify a user of a low battery situation in response to the information provided by the monitoring circuit 95 via the user feedback circuit 90.

The user feedback circuit 90 may be used to provide instructions, confirmations and/or other information to a user of the solid state storage drive 10. For example, the user feedback circuit 90 may be used to notify a user that the storage drive 10 has accepted a self-destruct command and/or that purging is under way. The user feedback circuit 90 may be controlled by a control signal that is generated by the second processor 80. In one exemplary embodiment, the user feedback circuit 90 comprises a buzzer that generates one or more audible signals under control of the second processor 80. However, as discussed herein, it will be appreciated that a wide variety of different user feedback devices 90 may be employed pursuant to various embodiments of the present invention. For example, the user feedback device 90 could also be implemented as a liquid crystal display, a vibrator, one or more light emitting diodes and/or as a dialog box on a host computer.

The components of the solid state storage drive 10 are typically encased in a housing (see FIG. 2) which protects the integrated circuit chips, buses and other electrical connections. Some or all of the internal components of the solid state storage drive 10 may be mounted on one or more printed circuit boards, and at least some of the electrical connections between components may be implemented as traces or transmission lines on these printed circuit board(s).

As noted above, blocks of the non-volatile memory modules 20 of the solid state storage drive 10 may be written to and read from under the control of a storage management function that is implemented by the processor 30. This capability is used in the normal use of the solid state drive 10 in order to operate the memory modules 20 so that data may be read and written to those blocks. The second processor 80 may seize control of the non-volatile memory modules 20. In particular, as shown in FIG. 1, a control line 81 is provided between the second processor 80 and each of the tri-state buses 35, 82. The second processor 80 may output a control signal on this control line 81 that floats all of the data lines between the first processor 30 and the tri-state bus 35, thereby effectively disconnecting the first processor 30 from the tri-state bus 35, allowing the second processor 80 to take full control of the bus 35. Once the second processor 80 has seized control of the non-volatile memory modules 20 by disconnecting the connection between the first processor 30 and the bus 35, the second processor 80 may send signals through tri-state bus 82 that systematically cause each non-volatile memory module 20 to perform a block erase operation on the data blocks of each module 20. The modules 20 may sequentially or simultaneously perform these block erase operations. In other embodiments, a control line or lines may be provided between the second processor 80 and the first processor 30 and the second processor 80 may instruct the first processor 30 to cause each non-volatile memory module 20 to perform these block erase operations. The purging process is conducted under internal battery power supplied by the battery 50 via the independent power supply 60 and therefore may be totally independent from the status of the storage drive 10 with respect to its host computer, or lack thereof.

As is known to those of skill in the art, in conventional SSD storage drives a significant portion of the memory cells may be reserved for use in error correction coding operations. For example, it is not uncommon for 30% or more of the memory blocks on the drive to be used for error correction coding. As these error correction code memory blocks do not store actual data, some of the storage drives according to embodiments of the present invention may omit performing the self-erase function on the error correction code memory blocks, and instead only erase the memory blocks that store actual data (which are referred to herein as “data blocks”). However, in other embodiments, all of the blocks of the non-volatile memory modules may be erased during the self-erase operation, including the error correction coding blocks.

As noted above, certain users, such as selected members of the government intelligence gathering communities, may be required to destroy storage drives in a manner that guarantees that no forensic reconstruction effort could recover any data from the drive. In order to assure this, the solid state storage drive 10 is further equipped with the high voltage power supply 65 which may be activated by the second processor 80 at the conclusion of the above-described self-erase process. The high voltage power supply 65 applies a series of high-energy pulses to, for example, the non-volatile memory modules 20, the SATA controller power bus 35 and the processor 30 in order to irreparably damage these components and render the device inoperable, and leaving each memory cell in a state where it is not possible to determine the data that was previously stored therein, even when highly sophisticated forensic data recovery techniques are used.

As the second processor 80 is independently powered by the battery 50 and power supply 60, the self-erase and self-destruct circuits of storage drive 10 may operate independent of the host computer 5. Thus, the self-erase and/or self-destruct functions can be performed even when the storage drive 10 has been removed from the host computer 5. This can be advantageous for military and intelligence users who may store the storage drive in vaults or other secure storage areas. In emergency situations, the storage drive 10 can be erased and/or destroyed without the need to install the storage drive 10 in a host computer 5.

FIG. 2 is a schematic plan view of a 2.5 inch version of the solid state storage drive 10 that shows the dimensions of one particular embodiment thereof. As shown by FIG. 2, the storage drive 10 may be designed to be compatible in every physical, electrical, and functional dimension to standard 3.5 and 2.5 inch SSD SATA drives. As such, the storage drives according to embodiments of the present invention may be designed so that they can be used in any applications calling for SATA drives. In cases where the solid state storage drive 10 is used to replace a functioning SATA drive that is already installed on a computer, the user may employ one of a wide variety of commercially available drive “cloning” utilities that can be used to duplicate the data stored on the current drive onto the solid state storage drive 10.

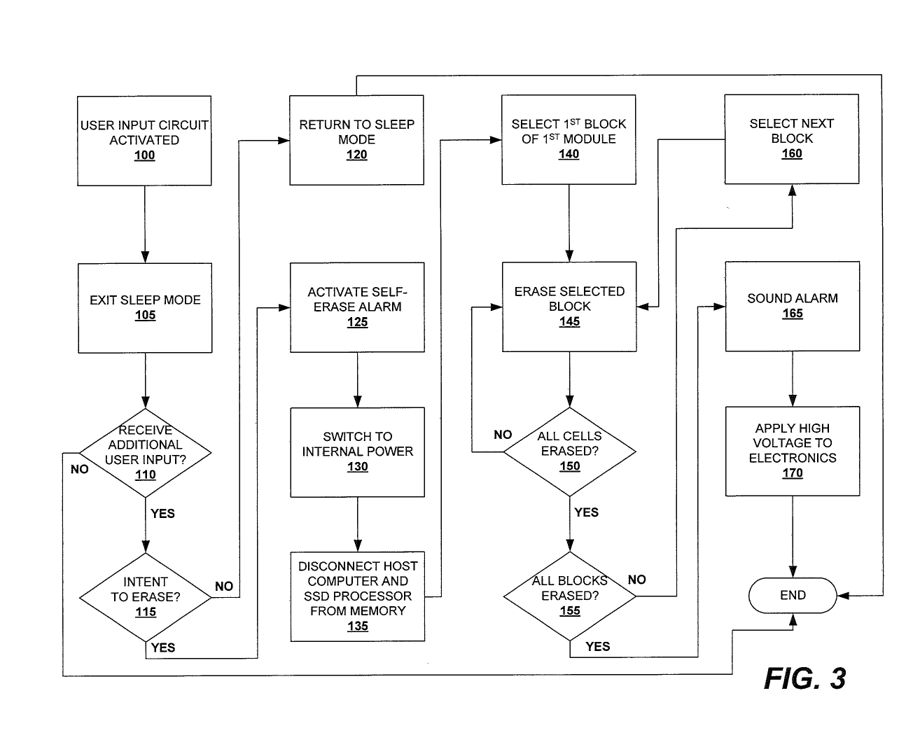

FIG. 3 is a flow chart that illustrates operations that may be used to self-erase the data stored on the solid state storage drive 10 and thereafter, to optionally self-destruct the storage drive 10. These operations may likewise be performed on other storage drives according to embodiments of the present invention. As shown in FIG. 3, operations may begin with activation of the user input circuit (block 100). With respect to the storage drive 10 of FIG. 1, this activation would comprise a user depressing either the external button 88 or the internal button 89 of user input circuit 86. In response to activation of the user input circuit, certain of the internal electronics on the storage drive including a processor that controls the self-erase function may exit a sleep mode (block 105). With respect to the storage drive 10 of FIG. 1, the wake-up circuit 84 may wake the internal power supply 60, the high voltage power supply 65 and/or the processor 80 at block 105. Next, the storage drive may await additional input from the user that confirms the user's intent to initiate the self-erase sequence (block 110). Such additional input may be required in some embodiments to help guard against accidental initiation of the self-erase operation. With respect to the storage drive 10 of FIG. 1, this additional input may comprise a sequence of button activations (i.e., a user pressing the external button 88 or the internal button 89 with a predefined sequence of pressings) that generate signals that are delivered to the processor 80 that confirm that it is the user's intent to activate the self-erase sequence. It will be appreciated, however, that in other embodiments different methods may be used to confirm the user's intent to initiate the self-erase function such as, for example, the activation by the user of a second user input circuit. It will also be appreciated that, in some embodiments, the confirmation step may be omitted (e.g., in embodiments in which a user has to break a tab or other part to gain access to the user input circuit).

Next, the solid state storage drive determines whether the received input from the user (e.g., the input received at block 100 and any additional input received at block 110) confirms an intent to erase the drive (block 115). With respect to the storage drive 10, the second processor 80 may be programmed to make this determination. If the solid state storage drive 10 determines that it was not the user's intent to initiate the self-erase function at block 115, the processor 80 (or wake-up circuit 84) may reset the drive electronics back to sleep mode (block 120), and operations may end. If instead, at block 115 the solid state storage drive 10 determines that it was the user's intent to initiate the self-erase function, operations proceed to block 125 where an optional self-erase alarm signal may be activated. With respect to the storage drive 10 discussed above, activation of this alarm signal may comprise providing the user feedback via the user feedback circuit 90. For example, in some embodiments, the user feedback circuit 90 may comprise a buzzer, and the alarm signal may comprise emitting a certain sound or series of sounds using the buzzer.

After the self-erase alarm signal is activated, the solid state storage drive 10 may switch the non-volatile memory modules 20 to be internally powered via the battery 50 and the internal power supply 60 (block 130). The second processor 80 may also disable the ability for the host computer to access the non-volatile memory modules 20, which may include, in some embodiments, preventing the processor 30 from accessing the non-volatile memory modules 20 (block 135). The first block of the first module 20 may then be selected by, for example, setting the block pointer for the non-volatile memory modules 20 to point to the first block of the first module 20 (block 140), and then a block erase procedure may be initiated to block erase all of the memory cells in the selected block (block 145). Next, a verification operation may be performed to determine if all of the memory cells of the selected block were successfully erased (block 150). If some cells were not properly erased, the block erase operation of block 145 may be repeated.

Once it is determined at block 150 that the block at issue was successfully erased, a determination is then made as to whether or not all of the blocks of all of the modules 20 have been erased (block 155). If blocks that have not been erased still remain, the next block in the module (or the first block in the next module if all of the blocks of the current module have been erased) is selected (block 160) so that the erase and verification operations of blocks 145 and 150 may be conducted on the next block. Once it is determined at block 155 that all of the blocks of all of the modules 20 have been erased, then an optional alarm may sound indicating that the self-erase sequence has been completed (block 165), and the self-erase operations are then completed.

As discussed above, some storage drives according to embodiments of the present invention may be physically destroyed in response to a user self-destruct command. The self-destruct command may be the same command as the self-erase command (i.e., in some embodiments, a single command causes both the self-erase and self-destruct operations to be performed), while in other embodiments separate commands must be entered to initiate the self-erase and self-destruct sequences. In the flow chart of FIG. 3, the self-erase command automatically acts to initiate both the self-erase and self-destruct operations, but it will be appreciated that in other embodiments the operations shown in FIG. 3 would be modified to receive a separate self-destruct command from the user prior to initiation of the self-destruct operations. As shown in FIG. 3, in the illustrated embodiment, the self-destruct operations may begin immediately after the alarm sounds indicating the end of the self-erase process, and involves supplying a high voltage (e.g., 600 volts) from a high voltage power supply to at least the non-volatile memory modules (block 170). In some embodiments, the high voltage may also be supplied to other electronics of the drive such as the SSD processor and/or the interface that connects the SSD processor to the non-volatile memory modules. In the storage drive 10 of FIG. 1, the high voltage may be supplied by the high voltage power supply 65 using the internal battery 50 as a power source. The high voltage may comprise a series of high voltage pulses that are delivered by the high voltage power supply 65 to the non-volatile memory modules 20, the SSD processor 30 and the bus 35 until the internal battery is fully discharged. In this manner, any and all trace of the data that was previously stored on the drive 10 is removed, and the electronics of the drive 10 itself are also rendered permanently inoperable.

As is made clear from the above discussion, the self-erase function causes the data in a significant number of the memory cells of the non-volatile memory modules 20 to be overwritten in such a way that the original data is no longer accessible, without damaging the underlying memory circuitry so that the solid state storage drive 10 remains usable. As such, the self-erase function provides a simple and reliable means of ensuring that all data is erased from storage drive 10 before the drive is, for example, removed from a host computer for use in another computer or for disposal purposes. In contrast, the self-destruct function applies voltages that destroy critical aspects of the memory circuits and hence render the solid state storage drive 10 non-operative and unusable. The self-destruct function, which typically is implemented after the self-erase function, is provided to help fulfill the stringent and sometimes life-threatening requirement placed on some users such as intelligence community operatives, top-secret project scientists and the like to ensure that no data can be recovered from the drive even when sophisticated forensic data recovery techniques are used. It will be appreciated that in some embodiments the self-destruct function may be implemented without first performing the self-erase function. However, typically both the self-erase and self-destruct operations will be completed in situations in which the drive 10 is to be destroyed in order to increase the probability that no data may be recovered from the drive 10. When only the self-erase function is initiated (and the drive either does not include the self-destruct functionality or this functionality was not used), the drive may be tested and recycled back into use on another computer after the self-erase function is completed.

One possible reason that a storage drive may be disposed of is that the drive has stopped functioning properly (i.e., the host computer can no longer use the drive as a storage device and may be unable to control the drive). The self-erase and self-destruct circuits in the storage drives according to embodiments of the present invention may be largely impervious to the operating condition of the rest of the electronics in the drive, and hence the self-erase and/or self-destruct functions may be successfully employed even in situations where the host computer is no longer able to control the storage drive. The ability to fully erase and/or destroy even a “crashed” storage drive through a simple activation sequence may be highly advantageous, and the storage drive 10 may be configured to provide the user confirmation that the self-erase and/or self-destruct operations have successfully destroyed the storage drive, even in situations where the storage drive has otherwise stopped functioning properly and/or is not installed in a host computer. This is important because forensic data reconstruction techniques may easily be performed on crashed storage drives for purposes of recovering data therefrom for a wide variety of improper purposes such as identity theft, trade secret misappropriation, etc.

Currently, the standard operating procedures for rendering memory storage drives that store highly classified military and intelligence information inoperable are quite severe, and may involve placing the storage drive in an explosion bin and setting off thermite grenades or the like. However, as noted above, the solid state storage drives according to certain embodiments of the present invention allow initiation of the self-destruct process via a user input circuit that is located on the outside of the computer on which the storage drive is installed in order to allow activation of the self-erase and/or self-destruct sequences without having to remove the storage drive from its host computer. This ability to initiate the self-erase and self-destruct processes without removing the drive may be particularly important for users involved in intelligence gathering and top-secret development work, as the need to initiate these processes may typically occur in a panic situation in which there is little or no time for any procedures requiring that the user look for tools and take the time to physically access the storage drive inside the computer such as, for example, during a hostile takeover of an embassy or military intelligence officers whose positions are being overrun during armed combat. In these cases, the self-erase and self-destruct processes may be used to render the storage drive permanently inoperable and to prevent any recovery of the data thereon. The self-destruct process may also render the host computer itself inoperable which, in the above situations, would likely be considered advantageous.

Competing interests exist with respect to the ease with which the self-erase and/or self-destruct processes may be initiated. On the one hand, in certain situations (particularly with respect to government, military and intelligence operatives working on foreign soil) there may be a need to allow users to very quickly and easily initiate one or both processes. On the other hand, the inadvertent or accidental erasure of all data on a storage drive (and/or the actual destruction of that drive) could result in the loss of months or even years of work, which might also be catastrophic for the user. As a result, pursuant to embodiments of the present invention different mechanisms are provided for initiating the self-erase and self-destruct features that provide different tradeoffs in terms of ease of initiation, cost of the unit, and protections against accidental erasure or destruction.

As discussed above, in some embodiments, a push button may be provided that is used to initiate both the self-erase and the self-destruct processes. This button may be located on the drive itself (i.e., an “internal” button) or may be mounted remotely somewhere on an accessible surface of the host computer (e.g., an external button). A sequence of pushes on the button may be used to initiate the self-erase and self-destruct procedures. Feedback such as audible signals may be provided to the user in the form of an internal buzzer or microprocessor-generated statements and commands. The button sequences used to initiate the otherwise irreversible self-erase and self-destruct processes may be implemented based on an “arm first and then fire” sequence which must be followed by the user in order to avoid accidental data erasure or storage drive destruction.

For example, with the solid state storage drive 10 illustrated in FIG. 1, a user may signal an intent to initiate the arming process with a long push to either the external button 88 or the internal button 89. When a pre-determined amount of time has passed, the user is prompted with an uninterrupted beep from the buzzer to release the button. If the user does not release the button within a few seconds of the sounding of the buzzer (or other pre-determined amount of time), the system disengages the arming sequence and resets to normal mode under the “assumption” that the button was accidentally pushed in and that the activation thereof did not represent an intent to initiate the self-erase and/or self-destruct processes.

If, instead, the user releases the button within a few seconds of the sounding of the beep, the arming sequence in concluded. A few seconds later, the buzzer sounds a series of short beeps that serves as a prompt for the user to press the button to confirm the start of the self-erase and self-destruct processes. The user must press and keep the button pressed until the sequence of short beeps turns to a continuous beep at which point the button must be released within a few seconds or the sequence is aborted. If the user releases the button within the few seconds of the beep turning constant, the constant beep will silence and be replaced by short chirps every few seconds signaling that the self-erase function is being performed to purge all data from the solid state storage drive 10. At the end of the self-erase sequence, the buzzer will stop chirping and emit one last flatline beep signaling the end of the self-erase process. The above description represents one exemplary set of commands that may be used to initiate the self-erase and self-destruct processes. It will be appreciated that a wide variety of different command formats may be used that provide different tradeoffs in terms of ease of use, probability of accidental initiation and the like. It will also be appreciated that the commands may be varied based on the type of user input circuits and user feedback devices (if any) provided with the particular solid state storage drive according to embodiments of the present invention.

In the high security drives where the self-erase process may be followed by a self-destruct process, the end of the chirping indicates the end of the self-erase process but then, the system emits one single beep of a few seconds in duration while it charges and arms the high voltage power supply 65. As soon as the high voltage power supply 65 discharge starts, the buzzer 90 is silenced and, since no electronics should be operable at the end of that process, no attempt is made by the system to sound off the end of the self-destruct process.

FIG. 4 is a schematic diagram illustrating one embodiment of a self adhesive external button 88 and a two wire connector 87 that may comprise the user input circuit 86 of FIG. 1. External buttons 88 may only be provided on some storage drives according to embodiments of the present invention, as such buttons would typically only be considered necessary or desirable with respect to classified government information. Typical consumer and enterprise use would likely be adequately served by an internal button or switch or the like that is mounted and accessible on, for example, the bottom of the storage drive and which can be accessed by the user or IT professional once the storage drive is removed from its host computer. The internal and external buttons may be configured to initiate the self-erase and self-destruct functions in exactly the same way.

While exemplary solid state storage drives have been described above, it will be appreciated that numerous modifications may be made thereto without departing from the scope of the present invention. By way of example, numerous user input circuits other than the internal button 89 and/or external button 88 (along with the two wire connection 87) may be used. In some embodiments, the storage drive may include a switch or key-lock switch instead of a button that is used to activate the self-erase and self-destruct functions. This switch may be directly accessible, may be recessed, or may be covered by a door, tab or other cover that makes it less likely that the switch will accidentally be flipped. In some embodiments, the user may have to physically tear or break away the cover in order to provide even further protection against accidental activation of the switch. In still other embodiments, the button or switch may be sufficiently recessed within a cavity that it may only be accessible using a stylus or other thin pointing device.

In still other embodiments, a thin keypad and display may be provided either on the housing of the storage drive or mounted externally (e.g., mounted on the housing of the host computer and electronically connected to the storage drive). In embodiments that include such keypads and displays, a user may be required to enter one or more passwords (e.g., a sequence of numbers) into the keypad to initiate the self-erase and/or self-destruct processes. The second processor 80 may be wired to the keypad and display, and may send signals to the display that provide instructions, questions and status information to the user such as “Initiate Self-Erase Process?”, “Enter Self-Erase Authorization Code”, “Self-Erase Complete”, “Initiate Self-Destruct Process?”, “Enter Self-Destruct Authorization Code” and the like. By requiring that the user enter such passwords or authorization codes before the storage drive will self-erase or self-destruct it is possible to all but prevent accidental activation of either the self-erase or the self-destruct processes. Additionally, the use of passwords may make it difficult for other individuals to maliciously initiate one or both of the self-erase or self-destruct processes as an act of vandalism, industrial espionage or the like.

By requiring in some embodiments that an arming sequence be initiated before the self-erase and/or self-destruct sequences can be initiated, the storage drives according to embodiments of the present invention include a safety mechanism that can greatly reduce the possibility of accidental loss of data. Additionally, since the self-erase and self-destruct sub-systems are essentially independent from the normal data storage functionality of the storage drive, the risk of accidental interaction of the codes of the two microcontrollers may be virtually eliminated, and thus the dual processor design that is provided in certain of the storage drives according to embodiments of the present invention may provide another important safeguard against accidental data loss.

As noted above, the storage drives according to embodiments of the present invention may include internal battery power and a charging circuit so that the storage drive has the ability to carry out its self-erase and self destruct functionality under any circumstances, specifically including when the storage drive has been removed from the host computer. The battery may be dimensioned so that it can hold charge for at least one 1 year from a full charge, and may be sized such that the charge is sufficient to reliably carry out both the self-erase and self-destruct functions.

The solid state storage drives according to embodiments of the present invention may meet the stringent requirements imposed on organizations and individuals in the process of disposing of data storage devices used in desktop and laptop computers in a manner that the data present in these storage drives cannot be retrieved or reconstructed by others after disposal.

In the foregoing description and the claims appended hereto, it will be understood that, although the terms first, second, etc. are used to describe various elements, these elements are not limited by these terms. Instead, the terms “first,” “second” and the like are only used to distinguish one element from another. For example, a first element could be termed a second element, and, similarly, a second element could be termed a first element, without departing from the scope of the present invention. As used in the present application, the term “and/or” includes any and all combinations of one or more of the associated listed items.

It will also be understood that when an element such as a integrated circuit chip, circuit, module or the like is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

While the present invention has been described above in terms of exemplary embodiments, it will be appreciated that the invention is not limited thereto. It will likewise be appreciated that the features and elements of the various embodiments described above can be combined in any way and/or combination possible to provide additional embodiments.

As will be appreciated by one of skill in the art, certain components of the solid state storage drives according to embodiments of the present invention may be implemented entirely in hardware, entirely in software, or as a combination of software and hardware, all of which may generally be referred to herein as a “circuit” or “module.” Thus, it will be appreciated that a circuit may be implemented in a wide variety of different ways such as, for example, as software running on a processor or as an array of logic gates, or as a combination thereof.

Embodiments of the present invention are described above with reference to flowchart illustrations and block diagrams. It will be understood that the operations specified in the blocks in the flowcharts need not necessarily be implemented in the order indicated, but that instead the operations of certain blocks may be performed in a different order from that which is indicated or may be carried out simultaneously. It will likewise be appreciated that various of the blocks in the flowchart illustrations and block diagrams may be omitted in certain embodiments.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. An internal solid state storage drive for a host computer, comprising:
a solid state memory cell array that includes a plurality of non-volatile memory cells;
a first processor that is configured to control write operations to the solid state memory cell array and read operations from the solid state memory cell array; and
a second processor that is separate from the first processor, the second processor configured to block erase substantially all data blocks of the solid state memory cell array in response to a user input self-erase command.

2. The internal solid state storage drive of claim 1, further comprising:
a housing that is configured to be received within a slot on the host computer;
a battery that is mounted within the housing; and
a power supply that is within the housing and powered by the battery and that is configured to provide an operating voltage to the second processor,
wherein the solid state memory cell array, the first processor and the second processor are also mounted within the housing.

3. The internal solid state storage drive of claim 2, further comprising a self-destruct circuit that is configured to deliver a high voltage to the solid state memory cell array.

4. The internal solid state storage drive of claim 3, wherein the self-destruct circuit comprises a high voltage power supply that is powered by the battery, wherein the high voltage power supply is configured to supply a series of high voltage pulses to the solid state memory cell array.

5. The internal solid state storage drive of claim 1, further comprising a wake-up circuit that is configured to cause the second processor to exit a low power usage state in response to an input signal.

6. The internal solid state storage drive of claim 1, further comprising a user input circuit that is configured to receive the self-erase command.

7. The internal solid state storage drive of claim 6, wherein the user input circuit is further configured to receive a self-destruct command from the user, wherein the solid state storage drive is configured to initiate a self-destruct process that renders the solid state memory cell array inoperable in response to the self-destruct command.

8. The internal solid state storage drive of claim 6, wherein the second processor is configured to take over control of the solid state memory cell array from the first processor in response to the user input self-erase command.

9. The internal solid state storage drive of claim 2, further comprising:
a power tap that taps power from a connection between the solid state storage drive and the host computer; and
a charging circuit that uses power received from the power tap to charge the battery.

10. The internal solid state storage drive of claim 6, further comprising a user feedback circuit that is configured to provide feedback to the user in response to information input via the user input circuit.

11. The internal solid state storage drive of claim 10, wherein the second processor is configured to block erase substantially all data blocks of the solid state memory cell array independently of the first processor and the host computer.

12. An internal solid state storage drive, comprising:
a housing;
a solid state memory cell array within the housing;
a battery within the housing;
a power supply circuit that receives power from the battery;
a self-destruct circuit that is powered by the power supply circuit, the self-destruct circuit configured to deliver a high voltage to the solid state memory cell array that renders the memory cells of the solid state memory cell array inoperable in response to a user input self-destruct command.

13. The internal solid state storage drive of claim 12, wherein the self-destruct circuit comprises:
a high voltage supply circuit that is configured to provide a high voltage to the solid state memory cell array; and
a self-erase/destruct processor that is configured to cause the high voltage supply circuit to deliver the high voltage to the solid state memory cell array in response to the self-destruct command, wherein the power supply provides an operating voltage to the self-erase/destruct processor.

14. The internal solid state storage drive of claim 12, further comprising a separate solid state drive processor that is configured to control write operations to the solid state memory cell array and read operations from the solid state memory cell array and to perform block erase operations on blocks of the solid state memory cell array.

15. The internal solid state storage drive of claim 14, wherein the housing is configured to be received within an internal slot on a host computer.

16. The internal solid state storage drive of claim 14, further comprising a self-erase circuit that is configured to block erase most all blocks of the solid state memory cell array in response to a user input self-erase command.

17. The internal solid state storage drive of claim 13, further comprising a wake-up circuit that is configured to cause the self-erase/destruct processor to exit a low power usage state in response to an input from the user.

18. The internal solid state storage drive of claim 16, wherein the self-erase/destruct processor is configured to take over control of the solid state memory cell array from the solid state drive processor in response to the user input self-erase command.

19. A method of preventing access to data stored within a solid state memory cell array of an internal solid state storage drive for a computer, the method comprising:
receiving a self-erase command via a user input circuit;
block erasing erase substantially all data storage blocks of the solid state memory cell array in response to the received self-erase command; and then
delivering a high voltage to the solid state memory cell array that renders the memory cells of the solid state memory cell array inoperable.

20. The method of claim 19, wherein the solid state storage drive is configured so that the block erasing and delivering the high voltage can be initiated without powering up the host computer.
